(19) United States
(12) Patent Application Publication
(10) Pub. No.: US 2025/0320884 A1
(43) Pub. Date: Oct. 16, 2025

(54) METHOD FOR FORMING A REINFORCED ALUMINUM COMPONENT AND REINFORCED ALUMINUM COMPONENT

(71) Applicant: Textron Aviation, Inc., Wichita, KS (US)

(72) Inventors: Amit A. Tamhane, Wichita, KS (US); Joshua R. Huston, Douglass, KS (US); Nishad S. Prabhu, Wichita, KS (US); Kishor E. Shelar, Wichita, KS (US)

(21) Appl. No.: 18/632,148

(22) Filed: Apr. 10, 2024

(51) Int. Cl. F16B 5/01; B64C 1/06; F16B 5/08; F16B 11/00

(52) U.S. Cl. CPC F16B 5/01; B64C 1/061; F16B 5/08; F16B 11/006

(57) ABSTRACT

In an embodiment a method includes forming a first aluminum sheet using a first hot form quench (HFQ) process, forming a second aluminum sheet using a second HFQ process, wherein at least one of the first HFQ process or the second HFQ process forms stiffening structures on a surface of the first aluminum sheet or the second aluminum sheet, joining together the first aluminum sheet and the second aluminum sheet so that the stiffing structures are placed between the first aluminum sheet and the second aluminum sheet thereby forming a reinforced aluminum component and constructing an aviation vehicle with the reinforced aluminum component.

### TECHNICAL FIELD

The present application refers to a method for making reinforced aluminum components and a related device. In particular, the present application refers to a method for making aluminum airframes.

### BACKGROUND

Outer surfaces or skins of an airframe are conventionally made by providing formed metal skins to which orthogonal stiffening elements are applied. The metal skins are formed in one step and stringers and frames, which eventually form the orthogonal stiffening elements, are manufactured in independent and separate steps. The metal skins and the stiffening elements are different, independent and distinct pieces. After forming the skins and the stiffening elements, the elements are arranged on and joined with the skins (e.g., fastened). A reinforced aluminum component manufactured according to such a method is shown in FIG. 1.

### SUMMARY

In accordance with an embodiment, a method includes forming a first aluminum sheet using a first hot form quench (HFQ) process, forming a second aluminum sheet using a second HFQ process, wherein at least one of the first HFQ process or the second HFQ process forms stiffening structures on a surface of the first aluminum sheet or the second aluminum sheet, joining together the first aluminum sheet and the second aluminum sheet so that the stiffing structures are placed between the first aluminum sheet and the second aluminum sheet thereby forming a reinforced aluminum component, and constructing an aviation vehicle with the reinforced aluminum component.

In accordance with another embodiment, an airframe includes a first aluminum sheet, a second aluminum sheet, and a non-orthogonal aluminum stiffening structure arranged between the first aluminum sheet and the second aluminum sheet.

In accordance with yet another embodiment, an airframe includes a first aluminum sheet, a second aluminum sheet, and an orthogonal aluminum stiffening structure arranged between the first aluminum sheet and the second aluminum sheet, wherein the orthogonal aluminum stiffening structure comprises stiffening elements, and wherein angles between the stiffening elements and an inner surface of the first aluminum sheet or the second aluminum sheet are more than 90 degrees.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows a conventional reinforced aluminum component;

FIG. 2 shows a flowchart of a method for manufacturing a reinforced aluminum component for an aviation vehicle according to embodiments; and

FIGS. 3A-3B show reinforced aluminum components according to embodiments.

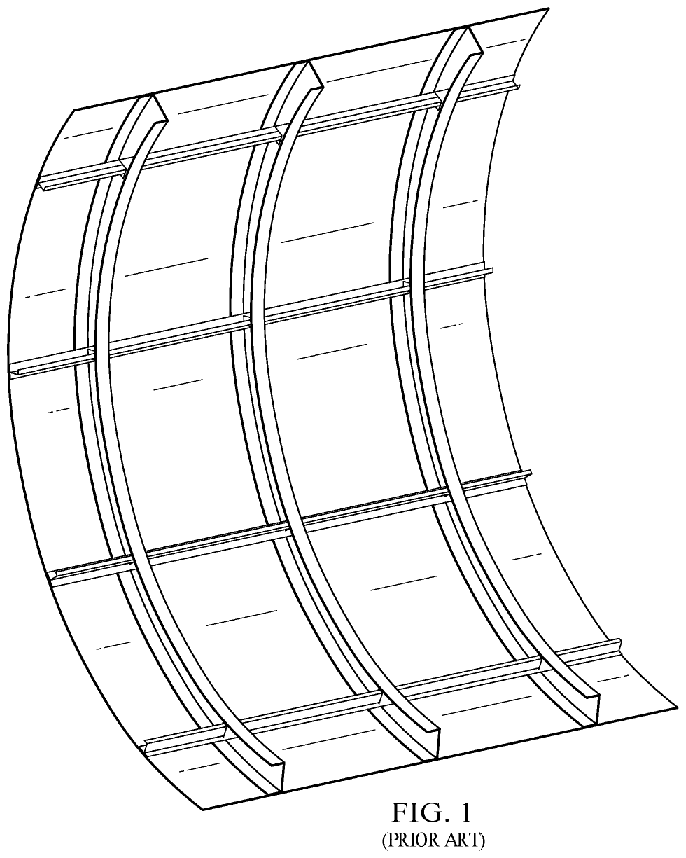

### DETAILED DESCRIPTION OF ILLUSTRATIVE EMBODIMENTS

Embodiments provide methods for making reinforced aluminum components to be assembled as an airframe of an aviation vehicle such an aircraft, a rotorcraft or a drone. The methods advantageously use a hot form quench (HFQ) process that allows to easily generate or design non-conventional stiffening structures (or stiffening elements) for the reinforced aluminum components. These processes have more degrees of freedom than conventional processes and the related stiffening structures may comprise or consist of non-orthogonal geometries. These methods may increase automation and may reduce part counts compared to conventional methods and related components and structures. They also allow advantageously a simplified process and a more rapid and economical construction of stiffened aluminum components, airframes and aviation vehicles.

The following methods describe a manufacturing process for forming stiffened or reinforced aluminum components. These are high-strength aluminum components that are lightweight and that may have complex inner shapes and stiffening structures.

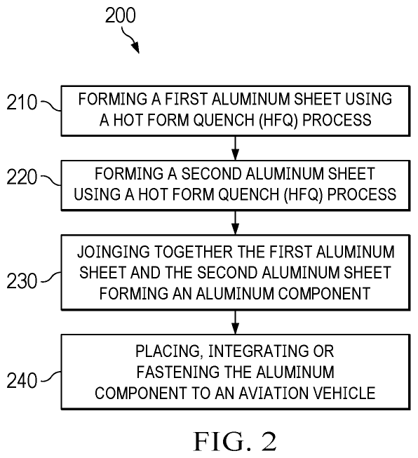

FIG. 2 shows a flowchart of a method 200 for manufacturing a reinforced aluminum component for an aviation vehicle according to a second embodiment.

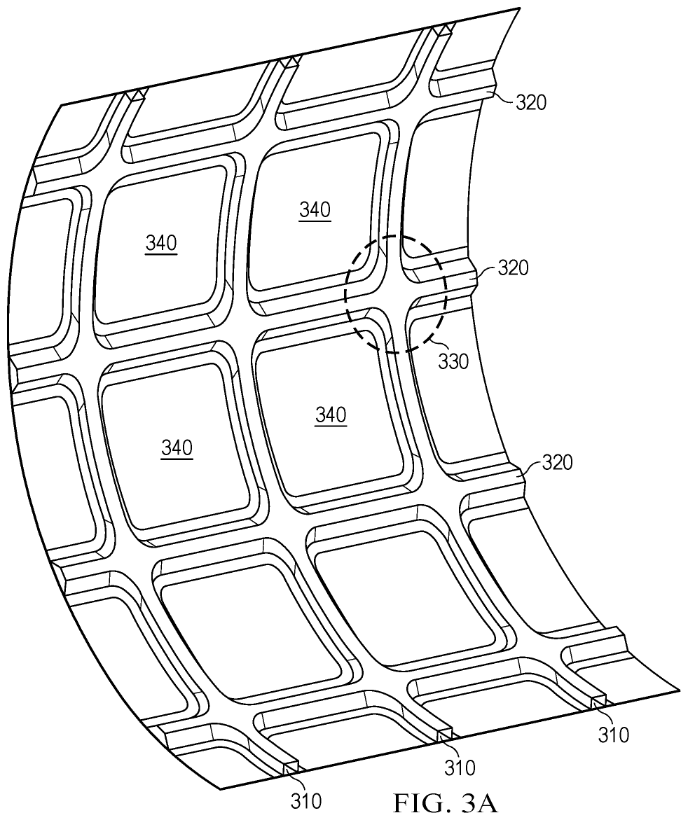

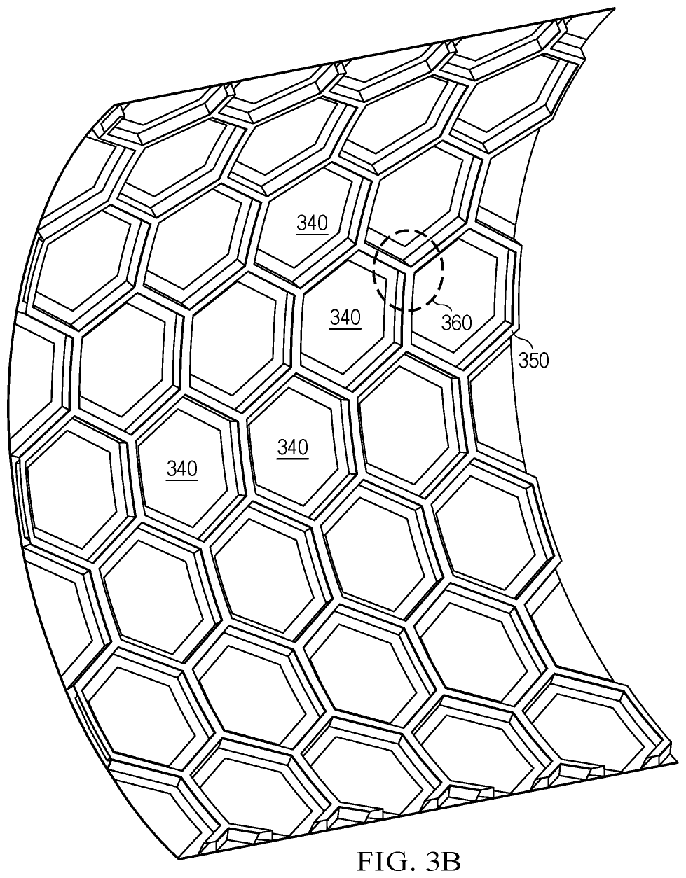

In an initial step 210 a first aluminum sheet is provided. The first aluminum sheet is elongated i.e., has a long side and a short (wide) side. The first aluminum sheet is much longer and wider than it is thick. The first aluminum sheet may have a thickness between 0.01 inches to 0.2 inches, between 0.016 inches to 0.125 inches or between 0.02 inches to 0.1 inches. Other thicknesses are possible. The first aluminum sheet contains an aluminum material such as an aluminum alloy. The aluminum alloy may be aluminum alloy 2024, aluminum alloy 6061 or aluminum alloy 7075 or other aerospace aluminum alloys. The first aluminum sheet is formed by applying a first hot form quench (HFQ) process. The first HFQ process typically involves heating the aluminum material to a pliable forming temperature, shaping it into the desired form, while rapidly cooling or quenching it to retain the formed shape with enhanced material properties. After applying the first HFQ process the aluminum sheet has a stiffened form and may include a stiffening geometry or a stiffening structure as shown in FIG. 3A-3B on an inner surface. Other stiffening geometries or a stiffening structure are possible.

In a next step 220, a second aluminum sheet is created with a second HFQ process. The second HFQ process may be the same or different than the first HFQ process. The second aluminum sheet may include the same or different aluminum alloys as the first aluminum sheet. The second aluminum sheet may have the same long and wide dimensions as the first aluminum sheet as well as the same or a similar thickness. In various embodiments the second aluminum sheet may be formed without any stiffening structure (stiffening elements).

In the next step 230, the first and second aluminum sheets are joint together, for example, by bonding to create the reinforced aluminum component. In various embodiments, only the first aluminum sheet comprises the stiffening elements while the second aluminum sheet does not comprise any stiffening elements. These two sheets are joint together so that the second aluminum sheet provides the outer loft of an aviation vehicle. Alternatively, the first aluminum sheet may provide the outer loft.

In other embodiments, the first aluminum sheet and the second aluminum sheet may include respective complementary portions of the stiffening structure on inner surface sides of the sheets (e.g., one has only horizontal stiffening elements while the other has only vertical stiffening elements) so that when they are joint together they form the complete stiffening structure with the geometry shown, e.g., in FIGS. 3A-3B. In this case, the formation of the second aluminum sheet may be similar to the formation of the first aluminum sheet.

In yet other embodiments, the first aluminum sheet and the second aluminum sheet are formed with the same (HFQ) process and include the same reinforcement geometry or structure and, when joint together, provide a reinforcement aluminum component with “double” the stiffening structure height of each sheet.

Joining may include bonding the sheets together. Bonding may be achieved by adhesive bonding, fastening or welding. Welding may include, e.g., laser welding, fusion welding or resistance welding.

In a final step, at 240, the reinforced aluminum component is placed, integrated or fastened to an aviation vehicle such as a rotorcraft, an aircraft or a drone. The reinforced aluminum component may be a fuselage skin (or a portion thereof), a wing skin (or a portion thereof) or an empennage skin (or a portion thereof). The method can also be used to build other parts of an aviation vehicle. In various embodiments the method can also be used to make parts of vehicles other than aviation vehicles.

The flowchart clearly outlines the sequential process steps, indicating the progression from raw material formation to the integration of stiffening elements for the creation of a structurally enhanced aluminum component. Some of the steps may be performed before or at the same time as other process steps or another process step. For example, steps 210 and 220 can be performed at the same time or the steps can be performed one after the other.

FIG. 3A shows an aluminum sheet with an orthogonal geometry and essentially orthogonal stiffening structure according to embodiments. The horizontal stiffening elements 310 (along a length direction of the aluminum sheet) and the vertical stiffening elements 320 (along a width direction of the aluminum sheet) may have the same width dimensions outside the crossing points or connection points 330. The stiffening elements may have all the same height and an angle of more than 90 degrees (more than 95 degrees, more than 100 degrees, more than 105 degrees) with respect to the inner surface 340 of the aluminum sheet. Moreover, the stiffening elements 310, 320, having substantially orthogonal main directions may have rounded corners at the crossing points 330 of the horizontal and vertical stiffening elements 310, 320.

FIG. 3B shows an aluminum sheet with a non-orthogonal structure and non-orthogonal stiffening elements 350 according to embodiments. The stiffening elements 350 may form a hexagonal web. The stiffening elements 350 may all have the same height and an angle of more than 90 degrees (more than 95 degrees, more than 100 degrees, more than 105 degrees) with respect to the inner surface 340 of the aluminum sheet. They may have all the same width dimensions outside the connection points 360. Moreover, the stiffening elements 350 may have rounded corners at the connection points 360.

Other orthogonal or non-orthogonal stiffening structures and geometries are possible. For example, the stiffening elements may form geometries comprising webs (similar to the web of the hexagonal structure) with heptagonal structure, with octagonal structures, with nonagonal structure or with decagonal structure. Alternatively or additionally, the stiffening elements or geometries may comprise contiguous, bordering or abutting circles or isolated, separate or noncontiguous circles.

In yet other embodiments, the stiffening structures may be even more complex. Complex in this context may mean that the stiffening elements may have contiguous round portions with a radius of curvature (not edges). A repeating pattern of stiffening elements may not consist of only one stiffening form, e.g., a rectangle or a hexagon, but may consist of several different stiffening structures, e.g., a combination of several different rectangles or a combination of rectangles and other (regular or irregular) polygon shaped structures and/or round shaped structures.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method comprising:
forming a first aluminum sheet using a first hot form quench (HFQ) process;
forming a second aluminum sheet using a second HFQ process,
wherein at least one of the first HFQ process or the second HFQ process forms a stiffening structure on a surface of the first aluminum sheet or the second aluminum sheet;
joining together the first aluminum sheet and the second aluminum sheet so that the stiffing structures are placed between the first aluminum sheet and the second aluminum sheet thereby forming a reinforced aluminum component; and
constructing an aviation vehicle with the reinforced aluminum component.

2. The method of claim 1, wherein the stiffening structure is orthogonal.

3. The method of claim 1, wherein the stiffening structure is non-orthogonal.

4. The method of claim 1, wherein the stiffening structure is hexagonal.

5. The method of claim 1, wherein the first HFQ process and the second HFQ process form respective complementary stiffening elements that when joint form the stiffening structure.

6. The method of claim 1, wherein the first HFQ process forms the first aluminum sheet with the stiffening structure and the second HFQ process forms the second aluminum sheet with no stiffening structure.

7. The method of claim 1, wherein the reinforced aluminum component is an airframe.

8. The method of claim 1, wherein the reinforced aluminum component is a fuselage, a wing, or a empennage skin.

9. The method of claim 1, wherein joining together comprises adhesive bonding the first and second aluminum sheets.

10. The method of claim 1, wherein joining together comprises fastening the first and second aluminum sheets.

11. The method of claim 1, wherein joining together comprises welding the first and second aluminum sheets.

12. The method of claim 1, wherein the first aluminum sheet or the second aluminum sheet comprises aluminum alloy 2024, aluminum alloy 6061 or aluminum alloy 7075.

13. A reinforced aluminum component comprising:
a first aluminum sheet;
a second aluminum sheet; and
a non-orthogonal aluminum stiffening structure arranged between the first aluminum sheet and the second aluminum sheet,
wherein the reinforced aluminum component is an airframe.

14. The reinforced aluminum component of claim 13, wherein the non-orthogonal aluminum stiffening structure is an integral part of the first aluminum sheet or the second aluminum sheet.

15. The reinforced aluminum component of claim 14, wherein the non-orthogonal aluminum stiffening structure comprises stiffening elements, and wherein first stiffening elements are an integral part of the first aluminum sheet and second stiffening elements are an integral part of the second aluminum sheet.

16. The reinforced aluminum component of claim 13, wherein the first aluminum sheet and the second aluminum sheet are welded or fastened together.

17. The reinforced aluminum component of claim 13, further comprising an adhesive located between the first and second aluminum sheets, wherein the adhesive directly contacts the first aluminum sheet and the second aluminum sheet respectively.

18. The reinforced aluminum component of claim 13, wherein the first aluminum sheet or the second aluminum sheet is formed with a hot form quench (HFQ) process.

19. A reinforced aluminum component comprising:
a first aluminum sheet;
a second aluminum sheet; and
an orthogonal aluminum stiffening structure arranged between the first aluminum sheet and the second aluminum sheet,
wherein the orthogonal aluminum stiffening structure comprises stiffening elements,
wherein angles between the stiffening elements and an inner surface of the first aluminum sheet or the second aluminum sheet are more than 90 degrees, and
wherein the reinforced aluminum component is an airframe.

20. The reinforced aluminum component of claim 19, wherein the stiffening elements have all the same height.
